(19) United States
(12) Patent Application Publication
(10) Pub. No.: US 2006/0030977 A1
(43) Pub. Date: Feb. 9, 2006

(54) Obstacle warning system for railborne vehicles

(76) Inventors: Helmut G. Klausing, Wessling-Hochstadt (DE); Jochem G. Kaeppel, Didderse (DE)

Correspondence Address: PENDORF & CUTLIFF, 5111 MEMORIAL HIGHWAY, TAMPA, FL, 33634-7356, US

(21) Appl. No.: 10/540,350

(22) PCT Filed: Nov. 27, 2003
(86) PCT No.: PCT/DE03/03921

§ 371 Date: Jun. 21, 2005

(30) Foreign Application Priority Data
Dec. 21, 2002 (DE) 10260555.6

(51) Int. Cl. G06F 17/00

(52) U.S. Cl. 701/19; 701/301

(57) ABSTRACT

The invention relates to an obstacle warning system for railborne vehicles, particularly for high-speed trains, comprising of at least one sensor (S1, S2) that is mounted on the railborne vehicle. According to the invention, the sensor (S1, S2) is aligned transverse to the direction of travel of the railborne vehicle (Fz) whereby enabling the detection of potential obstacles located within the structure clearance of a vehicle that is adjacent to the travel way of the vehicle (Fz).

### BACKGROUND OF THE INVENTION

1. Field of the invention

The invention concerns a system for obstacle warning in railborne traffic.

2. Related Art of the Invention

In the operation of transportation systems there exists, independent of the respective technological form of transport, the need that the structural clearance predetermined dynamically by the movement of the vehicle be maintained free of those obstacles that have a composition sufficient to represent a potential endangerment of the vehicle operation per se or, as the case may be, the safety of the operations (that is the safety of passengers, operating personnel and third parties).

In particular in railborne traffic, where on the one hand a circumnavigation of obstacles is as a rule impossible and, on the other hand, it is more difficult, due to the long braking distance, to bring the vehicle to a stop ahead of the obstacle, this task is of particular importance.

The task is even greater for rail traffic with high-speed (wheel-rail-systems such as, for example, TGV, ICE; magnetic levitation tracks, in particular Transrapid):
The braking distance is substantially longer due to the high-speed, that is, preceding obstacles must already be recognized far in advance, in order to enable a timely braking.
The detection of obstacles is substantially more difficult for humans due to the dynamics of the process in high speed travel. Also, the reaction time following a recognition is orders or magnitude longer in comparison to a technological system.
The consequences of a collision with an obstacle at higher speeds are substantially more serious, in particular also the endangerment of third parties by parts thrown from the location of the collision, in particular in high density populated regions.

Thus, for such systems, as a rule, prophylactic measures such as, for example, the erection of barriers and other such limitations on access are put into place. The risks remaining after such measures, which always include such dangers such as sabotage, terror, vandalism, accidents on adjacent tracks, etc., could be further minimized, if it were possible to recognize potential dangerous obstacles in time. On the basis of this information the respective endangered vehicle could be brought to stop in good time ahead of the obstacle or, as the case may be, traffic on the affected rails could be suspended for such a period of time until the obstacle could be removed.

The recognition and avoidance of ahead-lying obstacles by means of a vehicle mounted forward viewing sensor is hardly realizable or, as the case may be, economically too expensive for railborne high-speed transport systems due to the dynamics of the process.

Beyond this, U.S. Pat. No. 6,417,765 discloses a rail borne sensor carrier, which travels a sufficient distance ahead of the railborne vehicle in order to be able to warn the vehicle in a timely manner of ahead-lying obstacles. A system of this type is likewise associated with high technical complexity and expense.

### SUMMARY OF THE INVENTION

It is thus the task of the present invention to provide a suitable low cost and therewith economically realizable system for obstacle warning for application to high-speed transport systems. This task is solved with the subject matter of claim 1. Advantageous embodiments are the subject matter of the dependent claims.

The inventive system includes at least one sensor provided on the rail guided vehicle, wherein the sensor is oriented towards the railway of the lane adjacent to the rail of the railborne vehicle, so that potential obstacles within the structural clearance of the adjacent railway can be recognized. The inventive system thus detects not obstacles lying ahead of the own vehicle, but rather those which are located on the adjacent rails. Since the railways of modern rail systems include at least two lanes of travel, the invention is universally employable.

The obtained obstacle information, including indications as to the obstacle location, can be relayed to a control central. This enables the selected closure of the concerned rail section and the targeted (time saving) employment of clearance and maintenance services.

Alternatively, or in addition, a prevention or as the case may be interruption of the travel on the adjacent rail can occur. In the case of sufficient reliability of automatic classification of the obstacle, this can also occur automatically. For this, a connection to the central control system is necessary. This leads to a reduction in work load as well as to an independence from human reaction times and liability to mistakes.

For the automatic recognition of potential dangerous objects on the transverse adjacent rail line during the drive-by at high speed (typically 500 km/h), preferably a high-resolution image-forming sensor and a rapid processor of collected or registered data is employed.

The sensor can in particular be an optical sensor (for example an IR sensor or a radar sensor).

It is possible for example that the detection of objects begins starting with a certain size considered to be critical. As a rule it is however not the size of the object that is determinative, but rather the mass and consistently. Thus the size alone can provide only one reference value. Thus the employment of image processing and pattern recognition processes are useful, in order to separate or distinguish critical from non-critical objects (for example a large bird sitting upon the rail is not considered a critical obstacle for a high-speed train, in contrast however to a piece of concrete of the same size).

Alternatively however the image could be transmitted to the operation central for evaluation of the obstacle and determining of suitable measures to be undertaken by humans.

A particularly advantageous embodiment of the inventive system is the provision of respectfully one sensor at the head of the train and one sensor at the end of the train. It can be assumed that “harmless” objects, which on the one hand may produce an alarm signal due to their size, however due to their consistency or composition represent no danger, may be blown away, that is removed, due to the wind from the passage of the vehicle. By the correlation of the sensor information from the head of the train with the respective sensor information from the tail end of the train it can be determined whether an object in the observed space still remains in the same location following the passage by of the train. If this is the case, then in a first decision step it can be assumed that this is an object with danger potential.

The interaction of different sensors (sensor/data fusion) may be necessary in order to increase the detection probability or, as the case may be, to reduce the rate of false alarms; for example, the combination of optical sensors (for example infrared sensors) with radar sensors. When combined, the following advantages of the inventive system result:
Reduction of the risk of obstacles on the railway during operation of railborne traffic systems;
With automatic detection and reaction, a relieving of the operation work, avoidance of human reaction time and liability to mistakes.

Advantageous incidental effects: With sufficient high resolution a system employed for obstacle warning can also be used for other purposes, for example:
The general evaluation of the quality of the railway, in order in certain cases to initiate specific maintenance measures (condition monitoring).
The automatic recognition of sinking/settling/warping on the base of seismic effects.
For obtaining inferences regarding the driving dynamics on the basis of the evaluation of sensor data, which extract from or are based on locationally fixed reference marks (also employable for locating or positionally fixing the train).

In the mentioned cases the data actually obtained by the sensors must be compared with previously collected reference data.

### BRIEF DESCRIPTION OF THE DRAWINGS

The invention is described in greater detail on the basis of a concrete embodiment. There is shown in respective schematic representation:

FIG. 1 An inventive system for obstacle warning, and

FIG. 2 the evaluation unit for processing the sensor data.

### DETAILED DESCRIPTION OF THE INVENTION

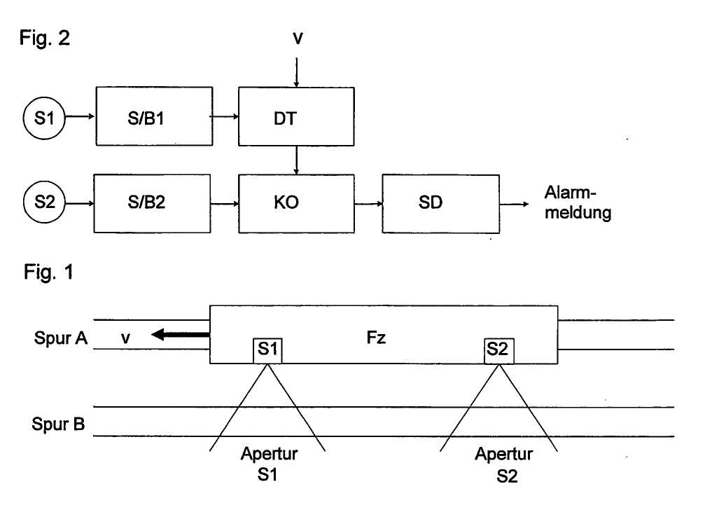

FIG. 1 shows an inventive system for obstacle warning. The railborne vehicle Fz, for example a magnetic levitated train, moves along rail A. In the area of the head as well as the end of the train Fz there is respectively provided one sensor S1, S2 of which the direction of view is oriented transverse to the direction of the vehicle Fz, so that obstacles on the adjacent rail B can be detected. In the shown embodiment the angle between the direction of travel of the vehicle Fz and the direction of view of the sensors is selected to be approximately 90°. It is however also to be noted, that in the framework of the present invention other angles can also be selected (for example, deviating from the exact transverse direction by ±30°), as long as it can be ensured, that the sensors cover the structure clearance profile of the adjacent rail B.

Since the railborne systems are basically directionally independent, that is, can be employed in both directions of travel, there is a possibility of a further—not shown—embodiment wherein the necessary sensors with appropriate evaluation electronics are mounted in both transverse directions on the vehicle Fz.

One possible design of the associated evaluation circuitry is shown in FIG. 2. The sensor data of the two sensors S1, S2 (FIG. 1) are first supplied separately to a signal/image processing unit S/B1, S/B2. In order to minimize false alarms, subsequently a correlation/image comparison is made of sensor data from the sensor S1 and S2. The sensor data of one of the two sensors must be previously subjected to a time delay (delay unit DT), which is proportional to the quotient of the distance of the mounted sensors S1, S2 in the vehicle Fz and the measured speed v.

In the threshold detector (SD) there occurs then a comparison of the sensor data with a predetermined threshold, wherein upon exceeding the threshold an alarm signal is emitted. The structural clearance refers to the space through which the railborne vehicle passes, and can be based on model profiles or programmed based on safety criteria.

1. A system for obstacle warning for railborne vehicles, in particular for high-speed trains, with at least one sensor (S1, S2) provided on the railborne vehicle, wherein
the sensor (S1, S2) is oriented transverse to the direction of travel of the railborne vehicle (Fz), so that potential obstacles within the structural clearance in the path of travel of a vehicle (Fz) of the adjacent rail can be recognized.

2. The system according to claim 1, wherein the sensor (S1, S2) is oriented at an angle of essentially 90° to the direction of travel of the railborne vehicle (Fz).

3. The system according to claim 1, wherein the sensor (S1, S2) is an optical sensor, in particular an IR-sensor and/or a radar sensor.

4. The system according to claim 1, wherein multiple sensor types are provided, of which the sensor data form the basis for evaluation.

5. The system according to claim 1, wherein at least two sensors (S1, S2), which are provided spaced apart from each other with respect to the direction of travel, and a correlation device (KO), in which a correlation of the sensor data of the two correlation (S1, S2) occurs.

6. The system according to one of the preceding Claims, wherein the railborne vehicle (Fz) operates according to the principle of rails/wheels or is magnetically levitated.

7. The system according to claim 1, wherein the sensors (S1, S2) are directed in both transverse directions of the railborne vehicle (Fz).

8. (canceled)

9. A method for obstacle warning for railborne vehicles, in particular for high-speed trains, comprising:
providing at least one sensor (S1, S2) on the railborne vehicle, wherein the sensor (S1, S2) is oriented transverse to the direction of travel of the railborne vehicle (Fz), and
using said sensor to recognize potential obstacles within the structural clearance in the path of travel of a vehicle (Fz) of the adjacent rail.

10. A method for evaluating the quality of the railway, for automatic recognition of land based anomalies along a railway, for inferences regarding the travel dynamic of the vehicle or for locationally fixing the vehicle, in particular for high-speed trains, comprising:
providing at least one sensor (S1, S2) on a railborne vehicle, wherein the sensor (S1, S2) is oriented transverse to the direction of travel of the railborne vehicle (Fz),
traveling along a first track adjacent to a second track, and
using said sensor to recognize the quality of said adjacent track, for automatic recognition of land based anomalies along said adjacent track, for inferences regarding the travel dynamic of the vehicle on the first track, or for locationally fixing the vehicle using geographic landmarks.
